(19) United States
(12) Patent Application Publication
(10) Pub. No.: US 2007/0006106 A1
(43) Pub. Date: Jan. 4, 2007

(54) Method and system for desensitization of chip designs from perturbations affecting timing and manufacturability

(75) Inventors: Steven C. Bartling, Plano, TX (US); Richard D. Vance, Richardson, TX (US); Marc E. Royer, Garland, TX (US); Charles M. Branch, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/171,163

(22) Filed: Jun. 30, 2005

(51) Int. Cl. G06F 17/50

(52) U.S. Cl. 716/6; 716/10

(57) ABSTRACT

The system and method disclosed here are directed to desensitization of paths to perturbations resulting from manufacturing faults. A threshold value for signal slew filters out some near-critical paths, and a mathematical formula is applied to determine the appropriate upsize for the cell driving the net along the near-critical path. The cell driving the net may be then be upsized in order to improve the timing through the cell, increase the positive slack, and reduce the sensitivity of the net to design perturbations.

### CROSS-REFERENCE TO RELATED APPLICATIONS

This application relates to the following commonly assigned co-pending application entitled “Method And System For Correcting Signal Integrity Crosstalk Violations,” Ser. No. ______, filed ______, Attorney Docket No. TI-60333 (1962-27600), which is incorporated by reference herein.

### BACKGROUND

1. Technical Field

The present subject matter relates to desensitizing chip designs from perturbations affecting timing and manufacturability. More particularly, the subject matter relates to a system and method for preventatively identifying and repairing near-critical paths that may result in timing violations during later design stages.

2. Background Information

An integrated circuit (“IC”) is a device that incorporates many electronic components (e.g., transistors, resistors, diodes, etc.). These components are often interconnected to form multiple circuit components (e.g., gates, cells, memory units, arithmetic units, controllers, decoders, etc.) on the IC. The electronic and circuit components of IC's are jointly referred to below as “components.” An IC also includes multiple layers of wiring (“wiring layers”) that interconnect its components. For instance, many IC's are currently fabricated with metal or polysilicon wiring layers (collectively referred to below as “metal layers”) that interconnect its components. One common fabrication model uses five metal layers.

Current chip implementation techniques create heavily optimized critical paths in circuitry and logic. Non critical-path circuitry, however, is not optimized, and merely meets minimum signal slew and capacitance load limits. “Near Critical” paths may be identified as those having positive slack, but only by a slight margin. The logic along these “near critical” paths is very sensitive to perturbations such as signal crosstalk induced delay variation, capacitance extraction variations, and silicon manufacturing process variations such as random dopant fluctuations and on chip geometric variations. The paths in the class of “near critical” paths often become critical when these perturbations are analyzed, meaning that new critical paths rise to the top of the critical list at every design stage as perturbations are examined. The end result is silicon with excessive sensitivity to manufacturing variations. Thus, it is desirable to identify and optimize at least a subset of “near critical” paths preventatively to preclude the design from becoming too sensitive in later design stages to the perturbations discussed above.

A standard cell library typically provides a set of discrete implementations (i.e. a “cell family”) of each logic function. The different implementations of a particular logic function are designed to drive different capacitive loads while maintaining similar rise/fall times for multiples of a standard load, usually one, two, and four. By choosing from among the library cells that drive specific loads, cells within nets in critical or near-critical paths may be replaced with a cell having similar function, but driving a different load to correct for various perturbations. Most existing libraries do not have multiple cell drives that are the same physical size. The cells start at 1×, and the next drive is 2×, having twice the number of “fingers” as in the 1× cell, so the cell is quite a lot larger in physical size). For this reason, upsizing a cell to a different driver often creates a perturbation in cell placement, requiring adjustments to the physical locations of neighboring cells to accommodate the increased physical size of the new victim driver. This prompts reconnection and re-routing of neighboring nets, and thus, invariably introduces new crosstalk violations. It is thus desirable to build a standard cell library that promotes desensitization to the perturbations discussed herein by offering multiple cell drives having the same physical size, so that drive strength may be increased for nets within a certain threshold without resulting over-optimization of all nets.

### SUMMARY

The problems noted above are addressed in large part by a system and method for correcting signal integrity crosstalk violations. Some illustrative embodiments may include a system comprising a processor for processing instructions, a memory circuit containing the instructions, the memory circuit coupled to the processor, a mass storage device for holding a design program operable to transfer the design program to the memory circuit, wherein the design program on the mass storage device comprises instructions for a method for optimizing near critical paths on an integrated circuit. The method of the design program comprises identifying one or more near-critical paths, each near-critical path driven by a cell, calculating an upsize value for each near-critical path, and swapping in the upsize value for the cell driving the near-critical path.

Other illustrative embodiments may include a computer-implemented tool comprising a standard cell library having one or more cell families comprising one or more cells, each cell having a drive strength, path reporting logic adapted to report the slew rate for one or more cells along one or more nets, threshold logic adapted to set a threshold value, and cell swapping logic adapted to exchange a first cell in a net for a second cell of the same cell family having a greater drive strength than the drive strength of the first cell, the cell swapping logic triggered by the slew rate exceeding the threshold value, wherein the cells in each cell family increase in drive strength from the smallest cell according to a mathematical formula.

Yet further illustrative embodiments may include a method of desensitization of near-critical paths, comprising identifying one or more near-critical paths, each near-critical path driven by a cell, calculating an upsize value for each near-critical path, and swapping in the upsize value for the cell driving the near-critical path. Identifying one or more near critical paths may further comprise setting a threshold value, examining a slew rate for each cell driving each near-critical path, and identifying whether each cell driving each near-critical path is under-driven.

Other illustrative embodiments may include a computer-readable storage medium containing software that, when executed by a processor, causes the processor to identify one or more near-critical paths, each near-critical path driven by a cell, calculate an upsize value for each near-critical path, and swap in the upsize value for the cell driving the near-critical path. Identifying one or more near critical paths may further comprise setting a threshold value, examining a slew rate for each cell driving each near-critical path, and identifying whether each cell driving each near-critical path is under-driven.

### BRIEF DESCRIPTION OF THE DRAWINGS

For a detailed description of various embodiments of the present disclosure, reference will now be made to the accompanying drawings in which:

FIG. 1 illustrates a flow diagram of a technique for desensitization of chip design, in accordance with at least some embodiments;

FIG. 2 is an illustration of a computer system that contains a design program for incorporating aspects of the present disclosure;

FIG. 3 is a block diagram of the computer of FIG. 2; and

FIG. 4 is a block diagram of various components shown in FIG. 3.

### NOTATION AND NOMENCLATURE

Certain terms are used throughout the following discussion and claims to refer to particular system components. This document does not intend to distinguish between components that differ in name but not function.

In the following discussion and in the claims, the terms “including” and “comprising” are used in an open-ended fashion, and thus should be interpreted to mean “including but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers broadly to a collection of two or more components and may be used to refer to an overall system as well as a subsystem within the context of a larger system. Further, the term “software” includes any executable code capable of running on a processor, regardless of the media used to store the software. Thus, code stored in non-volatile memory, and sometimes referred to as “embedded firmware,” is included within the definition of software.

A net is typically defined as a collection of pins that need to be electrically connected. A list of all or some of the nets in a layout is referred to as a net list. In other words, a net list specifies a group of nets, which, in turn, specify the interconnections between a set of pins.

The term “slew” refers to the time a signal takes to transition from low to high or high to low. The term “slack” refers to how closely a timing constraint is satisfied. Positive slack indicates that a time constraint is satisfied with a safety margin equal to the slack value. Circuits with positive slack are usually considered to be over-optimized, since the slack indicates that the circuit could either be operated at a higher speed or redesigned to operate at the same speed using less area or power. Negative slack indicates that a constraint is unsatisfied and cannot be satisfied unless delays in the circuit are modified by the amount of the slack.

### Detailed Description of the Preferred Embodiments

The following discussion is directed to various embodiments of the disclosure. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

The system and method of the present disclosure include analyzing “near critical” paths to determine where circuit sizing changes may be made preventatively to reduce the sensitivity to perturbations. An algorithm, according to embodiments of the present disclosure, is disclosed that can be applied to a mathematical description of a standard cell library to calculate the necessary cell drive strength changes to desensitize the near critical paths on a net-by-bet basis. The system and method of the present disclosure completes desensitization in one design iteration, eliminating many design iterations that typically occur over the course of stages of chip design. The system and method of the present disclosure identify nets likely to pose timing violations at some point during the design implementation and handles them preventatively, rather than in numerous repair iterations throughout the chip build process.

New Standard Cell Library

In accordance with one or more embodiments of the present disclosure, a standard cell library may be generated and used. For any given logic function, the drive-strength of the cell can be varied, a fact that may be useful in correcting crosstalk violations. For a typical 300-cell library, each logical function (such as, for example, a 4-input OR gate) will have from 1 to 10 electrical variants, comprising a “cell family.” There are, however, millions of possible variations of transistor sizes, producing radically different timing behavior. A cell library as disclosed herein promotes desensitization to perturbations by offering multiple cell drives having the same physical size, so near-critical paths may be optimized in terms of drive strength without causing additional timing problems or sensitivity to perturbations.

A cell sizing methodology is employed according to embodiments of the present disclosure, as described in U.S. application Ser. No. ______, filed concurrently herewith, entitled “Method and System for Correcting Signal Integrity Crosstalk Violations,” incorporated by reference in its entirety. The benefits of the present disclosure are apparent when employing a standard cell library having the following attributes:
A fine granularity of sizes, especially in smallest cell drive range, where granularity is needed most,
large numbers of drive strengths,
monotonically increasing drive strengths that follow a mathematical sizing formula, and
groups of cell drive strengths that are the same size with the same internal metallization and via locations.

A library sized according to the methodology described in U.S. application Ser. No. ______, filed concurrently herewith, entitled “Method and System for Correcting Signal Integrity Crosstalk Violations,” and employed according to embodiments of the present disclosure has a fine granularity of drive strengths in the smaller sizes where granularity is most important. As designs in the past have previously used 1× cells to overdrive 70% of the nets in a typical design (thus resulting in many potential aggressors), it is an improvement in the current standard cell library that there is variety in the drive strengths among the smaller sizes that are commonly employed, such that small optimizations may be made without any overkill. A large number of drive strengths may be available in the standard cell library of the present disclosure, with a significant number of the smaller cells having identical cell layout polygonal structures above the Polysilicon Contact and Diffusion Contact layers, allows upsizing to occur without changing the routing details and creating additional crosstalk violations. Alternatively, in an embodiment of the present disclosure, drive strengths may increase monotonically with a mathematical progression that has a similar effect to the logarithmic progression previously described in the related application.

Desensitization Algorithm-Optimization of Near Critical Paths

Employing the cell library described above, a desensitization algorithm according to embodiments of the present disclosure may be used to preventatively identify near-critical paths and optimize them before they show up as having timing violations. To accomplish desensitization, paths are identified as partially or completely unoptimized near-critical paths. A target and a target slew rate threshold (or a first and second slew rate threshold) may be used to control the aggressiveness of the desensitization algorithm. Reports from timing analysis may be analyzed to determine which nets are in the class of near-critical paths, according to their slew rate. Nets located along such paths may benefit by changes to the cell size/drive strength used to drive the net in order to desensitize the net to any perturbations that would affect path delay. The required changes are fed into a mathematical model of the standard cell library sizing. Using the mathematical model, the required cell sizing change may be determined in order to induce the level of timing changes desired to take a path out of the “near critical” category.

The algorithm disclosed here is enabled by examining Static Time Analysis (“STA”) reports. Specifically, by examining STA reports for paths having up to a threshold of positive slack (as much as several hundred picoseconds of positive slack), one may improve the timing margin on these paths before they become critical in later design stages.

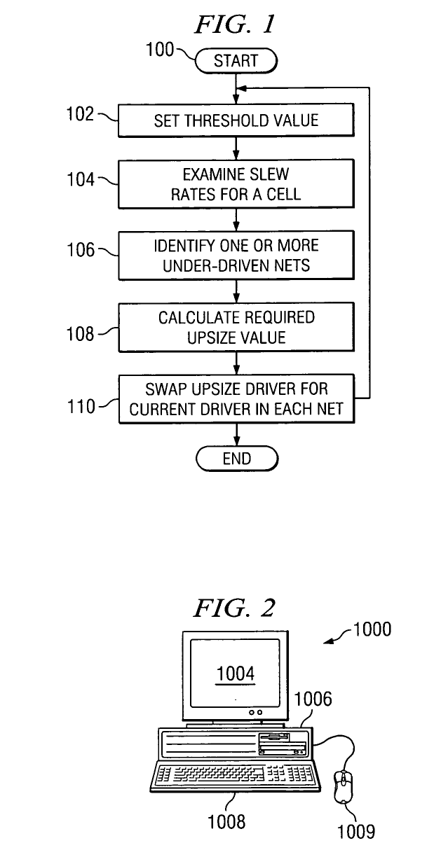

An algorithm to carry out the method described above may be employed as follows, and as shown in FIG. 1. The algorithm begins in block 100, and in block 102 a threshold value is set. The threshold value may be a target slew rate determined with some knowledge of what the range of slew values are for the maximum case for a given technology. By setting the target slew rate relative to the maximum case, a target slew rate (i.e. threshold value) may be set that is modest, but that will trigger an upsize for nets that have the weakest driver to net load ratios.

In block 104, the process involves examining the actual slew rates for a particular cell. The actual slew rates may be procured from an STA report. In block 106, under-driven nets are identified. Identifying under-driven nets may be carried out by comparing the actual slew rate for the cell (examined in block 104) to the threshold value (set in block 102) and triggering an upsize when the cell has a drive to net load ratio exceeding the threshold value.

In block 108, the upsize necessary to improve the timing on the near-critical path identified in block 106 may be calculated. The calculations performed to determine the upsize conform generally to the ASCII equations below:
(drive gain) [symbol] ^{step size}=drive strength multiplier Eq. 1
step size=Log (base=drive gain)*(drive strength multiplier) Eq. 2
step size=In (drive strength multiplier)/In(drive gain) Eq. 3
drive strength multiplier=1+(actual slew rate−threshold value) (actual slew rate) Eq. 4
Step size=In (1+actual slew rate−threshold value) (actual slew rate)/In(drive gain) Eq. 5

As used in the equations above, the step size increment is rounded to the nearest whole integer value. After rounding, step size represents the number of drive strength increments needed for a given library drive gain value in order to improve a near-critical path and increase the positive slack to desensitize the path to future perturbation analysis. In other words, if the drive strength of the cell driving the net is increased by the number of step size increments calculated, the timing on the net will be improved to some degree, making a near-critical path much less sensitive to perturbations down the line.

In block 110, the upsize calculated in block 108 may be swapped for the current cell in the under-driven net in order to improve the path timing. The process repeats in order to handle as many near-critical paths as are present in the path reports that exceed the threshold.

The approach described here does not determine the optimal slew rate value and drive cell sizing to achieve the optimal value, but rather approaches improvement of timing in small increments on a net-by-net basis. The method described above filters the nets on the near-critical paths, and triggers upsizing for the most under-driven nets that exceed the threshold, producing an overall improvement in path delay without over-optimization (causing increases in area and power consumption).

An example for a real semiconductor core may be meaningful. For a 90 nm ARM 946, prior to desensitization, a timing report resulted in 785 critical paths. In another report reporting to +2 ns of positive slack, an additional 6107 paths showed up—these paths were not desensitized, yet show up due to the wider range of slack reporting. Out of the original 785 paths that were processed with the desensitization algorithm, the number of the original paths that are present in the +2 ns slack post-desensitization report is 731, indicating that the number of paths whose worst path slack as improved beyond 2 ns is 54 paths. The overall effect was significant. The worst flop to flop violations in the top level of the chip design improved by 205 ps. The worst case top level timing path improved to −142 ps slack from −347 ps as a result of the desensitization modifications, all induced in a single iteration.

While upsizing cells in nets along near critical paths may have some effects on logic upstream from the net, such effects are generally negligible. The near critical paths are typically less problematic than those paths that are actually critical, and preventatively repairing in order to desensitize such paths to design perturbations may render them slightly slower than before. The result of desensitization as disclosed herein, however, is not usually a problem as the near critical paths generally have some timing margin. Small changes in the drive strengths of nets on such near critical paths can generate large cumulative improvement in overall path delay. At the same time, the small changes in drive strength implemented avoid over-optimizing near critical paths in a manner that adds large increases in area and power consumption.

In an embodiment of the present disclosure, the algorithm above may be combined with the algorithm disclosed in U.S. application Ser. No. ______, filed concurrently herewith, entitled “Method and System for Correcting Signal Integrity Crosstalk Violations.” One upsize calculation would result from the method for repairing crosstalk violations, and a second upsize calculation would result from the method disclosed herein. The larger of the two upsize calculations (resulting in the greater drive strength) would be chosen and implemented as the required cell drive strength increase. By choosing the larger upsize, the upsized cell would result in improving timing in order to desensitize the design to manufacturing perturbations as well as correct for crosstalk delay.

The System Description

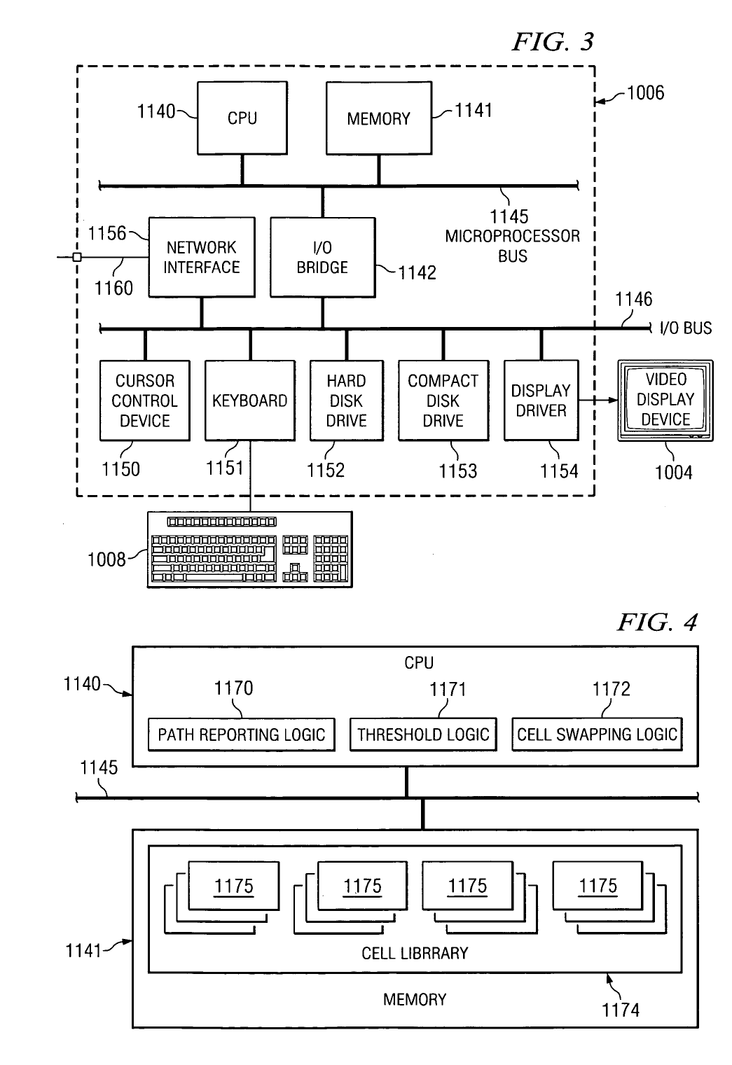

FIG. 2 is an illustration of a computer system 1000 which contains a design program incorporating aspects of the present disclosure, and FIG. 3 is a block diagram of the computer of FIG. 2. A design program that contains steps for designing an integrated circuit according to aspects of the present disclosure, as described in the following paragraphs, is stored on a hard drive 1152. This design program can be introduced into a computer 1000 via a compact disk installed in a compact disk drive 1153, or down loaded via network interact 1156, or by other means, such as a floppy disk or tape, for example. The program is transferred to memory 1141 and instructions which comprise the program are executed by processor 1140.

Portions of the integrated circuit design are displayed on monitor 1004. The design program includes a simulator for modeling and extracting parasitic effects and simulating the operation of the integrated circuit according to aspects of the present disclosure.

FIG. 4 is a block diagram of various components shown in FIG. 3. The CPU 1140 further comprises various logic components, including the path reporting logic 1170, the threshold logic 1171, and the cell swapping logic 1172. The memory 1141 may store a standard cell library 1174, which may be sized according to methods of the current disclosure. The standard cell library 1174 is comprised of one or more cell families 1175 comprising one or more cells. Each cell of each cell family 1175 has a drive strength.

The above disclosure is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.
What is claimed is:

1. A system, comprising:
a processor for processing instructions;
a memory circuit containing the instructions; the memory circuit coupled to the processor;
a mass storage device for holding a design program operable to transfer the design program to the memory circuit;
wherein the design program on the mass storage device comprises instructions for a method for optimizing near critical paths on an integrated circuit, the method comprising:
identifying one or more near-critical paths, each near-critical path driven by a cell;
calculating an upsize value for each near-critical path; and
swapping in the upsize value for the cell driving the near-critical path.

2. The system of claim 1, wherein the design program on the mass storage device comprises instructions for a method for optimizing near critical paths on an integrated circuit, wherein identifying one or more near critical paths further comprises:
setting a threshold value;
examining a slew rate for each cell driving each near-critical path; and
identifying whether each cell driving each near-critical path is under-driven.

3. The system of claim 1, wherein the design program on the mass storage device comprises instructions for a method for optimizing near critical paths on an integrated circuit, wherein the threshold value is a target slew rate.

4. The system of claim 1, wherein the design program on the mass storage device comprises instructions for a method for optimizing near critical paths on an integrated circuit, wherein the threshold value is subject to modification to control the number and magnitude of potential upsizes.

5. The system of claim 1, wherein the design program on the mass storage device comprises instructions for a method for optimizing near critical paths on an integrated circuit, wherein the threshold value is based on knowledge of a possible range of slew rates in a design.

6. The system of claim 1, wherein the design program on the mass storage device comprises instructions for a method for optimizing near critical paths on an integrated circuit, wherein identifying whether the cell is under-driven further comprises:
comparing the slew rate for the cell to the threshold value; and
triggering an upsize for an under-driven cell when the cell has a slew rate exceeding the threshold value.

7. The system of claim 1, wherein the design program on the mass storage device comprises instructions for a method for optimizing near critical paths on an integrated circuit, wherein the upsize value is directly proportional to the percentage difference between the threshold value and the slew rate.

8. The system of claim 1, wherein the design program on the mass storage device comprises instructions for a method for optimizing near critical paths on an integrated circuit, the method further comprising:
examining a slew rate for a plurality of cells;
identifying one or more nets that are under-driven;
calculating an upsize value for each under-driven net; and
swapping in the upsize values for each under-driven net.

9. A computer-implemented tool comprising:
a standard cell library having one or more cell families comprising one or more cells, each cell having a drive strength;
path reporting logic adapted to report the slew rate for one or more cells along one or more nets;
threshold logic adapted to set a threshold value; and
cell swapping logic adapted to exchange a first cell in a net for a second cell of the same cell family having a greater drive strength than the drive strength of the first cell, the cell swapping logic triggered by the slew rate exceeding the threshold value;
wherein the cells in each cell family increase in drive strength from the smallest cell according to a mathematical formula.

10. The computer-implemented tool of claim 9, wherein the threshold value is a target slew rate.

11. The computer-implemented tool of claim 9, wherein the mathematical formula is of the form: (drive gain)ˆ(step size)=drive strength multiplier.

12. The computer-implemented tool of claim 9, wherein one or more cells in a cell family may be of the same physical size while having different drive strengths.

13. The computer-implemented tool of claim 9, wherein one or more cells in a cell family may increase in size monotonically from the size of the standard cell.

14. A method of desensitization of near-critical paths, comprising:
identifying one or more near-critical paths, each near-critical path driven by a cell;
calculating an upsize value for each near-critical path; and
swapping in the upsize value for the cell driving the near-critical path.

15. The method of claim 14, wherein identifying one or more near critical paths further comprises:
setting a threshold value;
examining a slew rate for each cell driving each near-critical path; and
identifying whether each cell driving each near-critical path is under-driven.

16. The method of claim 15, wherein the threshold value is a target slew rate.

17. The method of claim 15, wherein the threshold value is subject to modification to control the number and magnitude of potential upsizes.

18. The method of claim 15, wherein the threshold value is based on knowledge of a possible range of slew rates in a design.

19. The method of claim 15, wherein identifying whether the cell is under-driven further comprises:
comparing the slew rate for the cell to the threshold value; and
triggering an upsize for an under-driven cell when the cell has a slew rate exceeding the threshold value.

20. The method of claim 14, wherein the upsize value is directly proportional to the percentage difference between the threshold value and the slew rate.

21. The method of claim 14, further comprising:
examining a slew rate for a plurality of cells;
identifying one or more nets that are under-driven;
calculating an upsize value for each under-driven net; and
swapping in the upsize values for each under-driven net.

22. The method of claim 14, wherein swapping in the upsize value for the cell is performed by a script.

23. The method of claim 14, wherein calculating an upsize value further comprises:
inputting the threshold value and the actual slew rate into a mathematical formula of the form: step size=In (1+actual slew rate−threshold value) (actual slew rate)/In (drive gain); wherein the step size in the increments used to achieve the upsize.

24. A computer-readable storage medium containing software that, when executed by a processor, causes the processor to:
identify one or more near-critical paths, each near-critical path driven by a cell;
calculate an upsize value for each near-critical path; and
swap in the upsize value for the cell driving the near-critical path.

25. The computer-readable storage medium containing software of claim 24, wherein identifying one or more near critical paths further comprises:
setting a threshold value;
examining a slew rate for each cell driving each near-critical path; and
identifying whether each cell driving each near-critical path is under-driven.

26. The computer-readable storage medium containing software of claim 25, wherein the threshold value is a target slew rate.

27. The computer-readable storage medium containing software of claim 25, wherein the threshold value is subject to modification to control the number and magnitude of potential upsizes.

28. The computer-readable storage medium containing software of claim 25, wherein the threshold value is based on knowledge of a possible range of slew rates in a design.

29. The computer-readable storage medium containing software of claim 25, wherein identifying whether the cell is under-driven further comprises:
comparing the slew rate for the cell to the threshold value; and
triggering an upsize for an under-driven cell when the cell has a slew rate exceeding the threshold value.

30. The computer-readable storage medium containing software of claim 24, wherein the upsize value is directly proportional to the percentage difference between the threshold value and the slew rate.

31. The computer-readable storage medium containing software of claim 24 that, when executed by a processor, causes the processor further to:
examine a slew rate for a plurality of cells;
identify one or more nets that are under-driven;
calculate an upsize value for each under-driven net; and
swap in the upsize values for each under-driven net.

32. The computer-readable storage medium containing software of claim 24, wherein swapping in the upsize value for the cell is performed by a script.

33. The computer-readable storage medium containing software of claim 24, wherein calculating an upsize value further comprises:
inputting the threshold value and the actual slew rate into a mathematical formula of the form: step size=In (1+actual slew rate−threshold value) (actual slew rate)/In (drive gain); wherein the step size in the increments used to achieve the upsize.
